(19) United States
(12) Patent Application Publication
(10) Pub. No.: US 2024/0253617 A1
(43) Pub. Date: Aug. 1, 2024

(54) CONTROL DEVICE FOR VEHICLE

(71) Applicant: HONDA MOTOR CO., LTD., Tokyo (JP)

(72) Inventors: Hiroki TAKAKU, Tokyo (JP); Gaku SHIMAMOTO, Tokyo (JP); Jumpei NOGUCHI, Tokyo (JP); Tatsuro FUJIWARA, Tokyo (JP); Ayumu MITOMO, Tokyo (JP); Takeshi SASAJIMA, Tokyo (JP)

(73) Assignee: HONDA MOTOR CO., LTD., Tokyo (JP)

(21) Appl. No.: 18/424,240

(22) Filed: Jan. 26, 2024

(30) Foreign Application Priority Data
Jan. 27, 2023 (JP) 2023-011050

(51) Int. Cl. B60W 30/06; B60K 35/28; B60W 50/06; B60W 50/10; B60W 50/14; B60W 60/00

(52) U.S. Cl. CPC B60W 30/06; B60K 35/28; B60W 50/06; B60W 50/10; B60W 60/001; B60K 2360/166; B60K 2360/175; B60W 2050/146

(57) ABSTRACT

A control device for a vehicle includes: a processor for performing control for autonomously parking the vehicle to a target position; and a storage unit storing a program necessary for travel control of the vehicle. As the control, the processor performs first control for starting movement of the vehicle to the target position in a state where a user of the vehicle is not in the vehicle, and second control for starting movement of the vehicle to the target position in a state where the user is in the vehicle, the processor updates the program, after a power of the vehicle is turned off and the processor executes the first control or the second control, and a start condition for updating the program is set more strictly when the first control is executed than when the second control is executed.

### CROSS-REFERENCE RELATED APPLICATIONS

This application is based on and claims priority under 35 USC 119 from Japanese Patent Application No. 2023-011050 filed on Jan. 27, 2023, the contents of which are incorporated herein by reference.

### TECHNICAL FIELD

The present disclosure relates to a control device for a vehicle.

### BACKGROUND

In recent years, efforts have been actively made to provide access to a sustainable transportation system in consideration of vulnerable people among traffic participants. In order to implement the above, the present inventors focus on research and development on further improving safety and convenience of traffic by research and development related to driving assistance techniques. As one of the driving assistance techniques, a parking assistance technique that assists parking of a vehicle is known (for example, see Japanese Patent Publication No. 4754883).

When parking assistance is provided, it is normally assumed that a vehicle will be stopped for a long period of time. Therefore, it is considered effective to update various programs that operate the vehicle after parking assistance is completed. However, depending on a situation where parking assistance is being performed and what is being performed, convenience may be impaired unless an execution timing of the program update processing is appropriately controlled.

The present disclosure aims to improve convenience after parking assistance is performed. The present disclosure will eventually contribute to development of a sustainable transportation system.

### SUMMARY

A first aspect of the present disclosure relates to a control device for a vehicle, the control device including:
a processor configured to perform parking assistance control for autonomously parking the vehicle to a target position; and
a storage unit that stores a program necessary for travel control of the vehicle, in which
as the parking assistance control, the processor is configured to perform first parking assistance control for starting movement of the vehicle to the target position in a state where a user of the vehicle is not in the vehicle, and second parking assistance control for starting movement of the vehicle to the target position in a state where the user is in the vehicle,
   the processor is configured to update the program, after a power of the vehicle is turned off and the processor executes the first parking assistance control or the second parking assistance control, and
   a start condition for updating the program is set more strictly when the first parking assistance control is executed than when the second parking assistance control is executed.

A second aspect of the present disclosure relates to a control device for a vehicle, the control device including:
a processor is configured to perform parking assistance control for autonomously parking the vehicle to a target position; and
a storage unit that stores a program necessary for travel control of the vehicle, in which
the processor is configured to perform first parking assistance control for starting movement of the vehicle to the target position in a state where a user of the vehicle is not in the vehicle as the parking assistance control,
   the processor is configured to update the program, after a power of the vehicle is turned off and the processor executes the first parking assistance control, and
   the processor is configured to determine whether to update the program based on a stopping position to which the vehicle is moved by the first parking assistance control and the target position.

A third aspect of the present disclosure relates to a control device for a vehicle, the control device including:
a processor configured to perform parking assistance control for autonomously parking the vehicle to a target position according to a travel plan; and
a storage unit that stores a program necessary for travel control of the vehicle, in which the processor is configured to perform first parking assistance control for starting movement of the vehicle to the target position in a state where a user of the vehicle is not in the vehicle as the parking assistance control, the processor is configured to update the program, after a power of the vehicle is turned off and the processor executes the first parking assistance control, and the processor is configured to determine whether to update the program based on a travel record of the vehicle moved by the first parking assistance control and the travel plan.

### BRIEF DESCRIPTION OF DRAWINGS

Exemplary embodiment of the present invention will be described in detail based on the following figures, wherein:

FIG. 1 is a diagram showing a vehicle 1 controlled by a control device according to an embodiment of the present disclosure;

FIG. 2 is a flowchart for explaining processing of a control device 30 when performing autonomous parking;

FIG. 3 is a flowchart for explaining a first modification of the processing of the control device 30 when performing autonomous parking; and

FIG. 4 is a flowchart for explaining a second modification of the processing of the control device 30 when performing autonomous parking.

### DESCRIPTION OF EMBODIMENTS

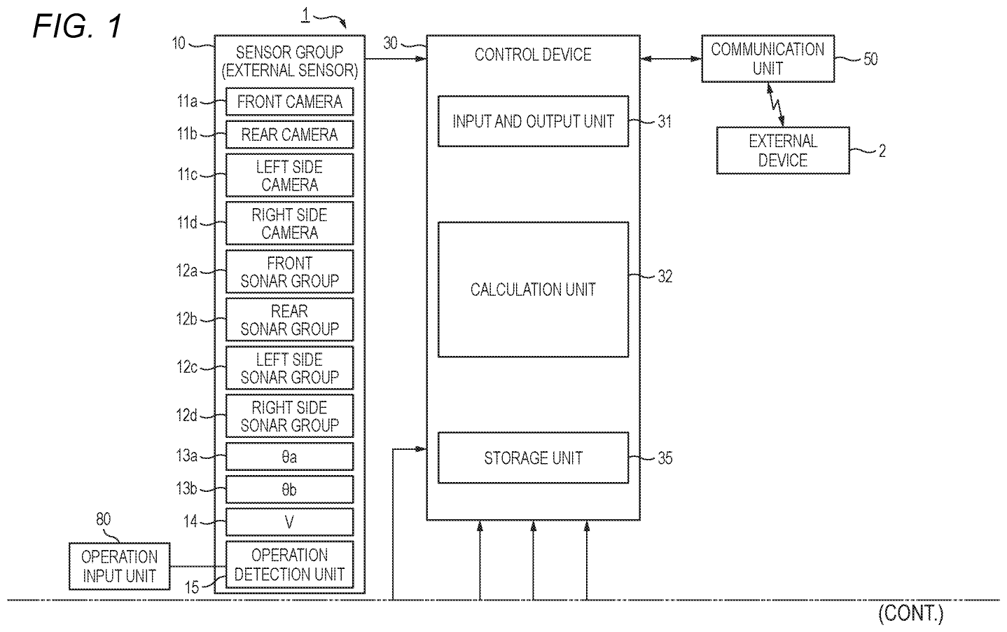

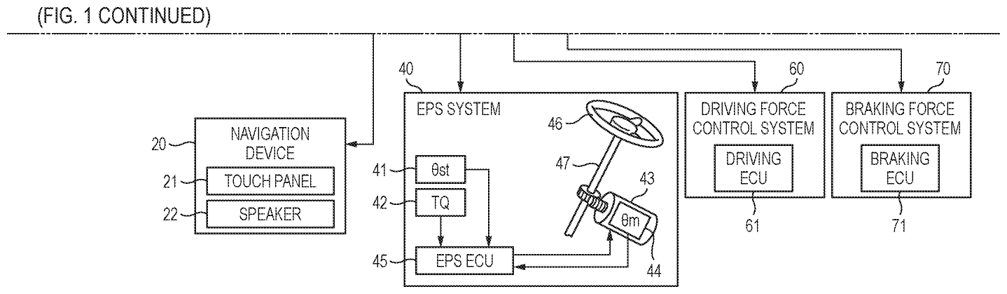

FIG. 1 is a diagram showing a vehicle 1 controlled by a control device according to an embodiment of the present disclosure. The vehicle 1 shown in FIG. 1 is an automobile including a drive source, and wheels (all not shown) including drive wheels driven by power of the drive source and steering wheels that are steerable. For example, the vehicle 1 is a four-wheeled automobile including a pair of left and right front wheels and a pair of left and right rear wheels.

The drive source of the vehicle 1 maybe an electric motor, an internal combustion engine such as a gasoline engine or a diesel engine, or a combination of an electric motor and an internal combustion engine. The drive source of the vehicle 1 maydrive the pair of left and right front wheels, the pair of left and right rear wheels, or the four wheels including the pair of left and right front wheels and the pair of left and right rear wheels. Either one of the front wheels and the rear wheels may be steerable steering wheels, or both the front wheels and the rear wheels may be steerable steering wheels.

The vehicle 1 is configured to be movable by automated steering toward a target position specified by a user (preferably a driver of the vehicle 1), who is an occupant of the vehicle 1.

As the target position, a position at which the vehicle 1 is parked (hereinafter also simply referred to as a “parking position”) may be set. That is, the vehicle 1 is capable of being parked by automated steering at the parking position specified by the user. Hereinafter, parking by automated steering to the parking position specified by the user is also referred to as “autonomous parking”.

In the vehicle 1, it is possible to select an in-vehicle parking mode or a remote parking mode as a mode of the autonomous parking.

The in-vehicle parking mode is a mode in which the autonomous parking is started by the user operates a device mounted on the vehicle 1, that is, in a state where the user is in the vehicle 1. The remote parking mode is mode that allows the user to start the autonomous parking remotely by operating a device separate from the vehicle 1 (an external device 2 described later), that is, in a state where the user is not in the vehicle 1. When the autonomous parking is performed in the remote parking mode, the user starts an application installed on the external device 2 such as a smartphone, gets out of the vehicle, and operates the application outside the vehicle 1 to start the autonomous parking.

As shown in FIG. 1, the vehicle 1 includes a sensor group 10, a navigation device 20, a control device 30, an electric power steering system (EPS system) 40, a communication unit 50, a driving force control system 60, a braking force control system 70, and an operation input unit 80.

The sensor group 10 obtains various detection values related to the vehicle 1 or a periphery of the vehicle 1. The detection values obtained by the sensor group 10 are sent to the control device 30 and used for the autonomous parking of the vehicle 1 and the like.

The sensor group 10 includes, for example, a front camera 11a, a rear camera 11b, a left side camera 11c, a right side camera 11d, a front sonar group 12a, a rear sonar group 12b, a left side sonar group 12c, and a right side sonar group 12d. These cameras and sonar groups may function as external sensors that obtain peripheral information of the vehicle 1.

The front camera 11a, the rear camera 11b, the left side camera 11c, and the right side camera 11d output, to the control device 30, image data of peripheral images obtained by capturing images of the periphery of the vehicle 1. The peripheral images captured by the front camera 11a, the rear camera 11b, the left side camera 11c, and the right side camera 11d are also referred to as a front image, a rear image, a left side image, and a right side image, respectively. An image formed by the left side image and the right side image is also referred to as a side image.

The front sonar group 12a, the rear sonar group 12b, the left side sonar group 12c, and the right side sonar group 12d emit sound waves to the periphery of the vehicle 1 and receive reflected sounds from other objects. The front sonar group 12a includes, for example, four sonars. The sonars constituting the front sonar group 12a are respectively provided on an obliquely left front side, a front left side, a front right side, and an obliquely right front side of the vehicle 1. The rear sonar group 12b includes, for example, four sonars. The sonars constituting the rear sonar group 12b are respectively provided on an obliquely left rear side, a rear left side, a rear right side, and an obliquely right rear side of the vehicle 1. The left side sonar group 12c includes, for example, two sonars. The sonars constituting the left side sonar group 12c are respectively provided in the front of a left side and in the rear of the left side of the vehicle 1. The right side sonar group 12d includes, for example, two sonars. The sonars constituting the right side sonar group 12d are respectively provided in the front of a right side and in the rear of the right side of the vehicle 1.

Furthermore, the sensor group 10 includes wheel sensors 13a and 13b, a vehicle speed sensor 14, and an operation detection unit 15. The wheel sensors 13a and 13b detect rotation angles θa and θb of the wheels (not shown), respectively. The wheel sensors 13a and 13b may be implemented by angle sensors or may be implemented by displacement sensors.

The wheel sensors 13a and 13b output detection pulses each time the wheels rotate for a predetermined angle. The detection pulses output from the wheel sensors 13a and 13b may be used to calculate the rotation angles and rotation speeds of the wheels. A moving distance of the vehicle 1 may be calculated based on the rotation angles of the wheels. The wheel sensor 13a detects, for example, the rotation angle θa of the left rear wheel. The wheel sensor 13b detects, for example, the rotation angle θb of the right rear wheel.

The vehicle speed sensor 14 detects a travel speed of a vehicle body (not shown) of the vehicle 1, that is, a vehicle speed V, and outputs the detected vehicle speed V to the control device 30. The vehicle speed sensor 14 detects the vehicle speed V based on, for example, rotation of a countershaft of a transmission.

The operation detection unit 15 detects an operation content performed by the user using the operation input unit 80 and outputs the detected operation content to the control device 30. The operation input unit 80 may include, for example, an operation button or the like that receives an operation for executing the autonomous parking. The operation input unit 80 and a touch panel 21, which will be described later, may be made common.

The navigation device 20 detects a current position of the vehicle 1 by using, for example, a global positioning system (GPS), and shows the user a path to a destination. The navigation device 20 includes a storage device (not shown) provided with a map information database.

The navigation device 20 includes the touch panel (touch screen) 21 and a speaker 22. The touch panel 21 functions as an input device that receives input of various types of information to the control device 30 and as a display device controlled by the control device 30. That is, the user may input various commands to the control device 30 via the touch panel 21. Various screens are displayed on the touch panel 21.

The speaker 22 outputs various kinds of guidance information by voice to the user. As an example, during autonomous parking, voice guidance may be performed via the speaker 22. Specifically, when movement by automated steering toward the parking position specified by the user is started, the start of the movement of the vehicle 1 may be notified by the voice guidance via the speaker 22.

The control device 30 is a device (computer) that generally controls the entire vehicle 1. The control device 30 includes, for example, an input and output unit 31, a calculation unit 32, and a storage unit 35. The input and output unit 31 is an interface that inputs and outputs data between inside and outside of the control device 30 under control of the calculation unit 32. The storage unit 35 includes a non-volatile storage medium, such as a flash memory, and stores various types of information (for example, data and programs) for controlling an operation of the vehicle 1.

The calculation unit 32 is implemented by a processor such as a central processing unit (CPU), and controls each element of the vehicle 1 by executing the programs stored in the storage unit 35 or the like. The calculation unit 32 performs the parking assistance control for autonomously parking the vehicle 1 to a target position (parking position). For example, the calculation unit 32 executes the parking assistance control when receiving an operation for executing autonomous parking via the input and output unit 31 or the like. The parking assistance control performed by the calculation unit 32 includes first parking assistance control performed in the remote parking mode and second parking assistance control performed in the in-vehicle parking mode.

The calculation unit 32 controls a display device (here, the touch panel 21) provided in the vehicle 1. For example, the calculation unit 32 may display an autonomous parking-related screen on the touch panel 21 in response to receiving the operation for executing the autonomous parking. The user sets the parking position on this autonomous parking-related screen.

When the user wants to start the autonomous parking in the in-vehicle parking mode, the user operates this autonomous parking-related screen and inputs a start instruction for autonomous parking to the control device 30. Upon receiving this start instruction, the calculation unit 32 starts executing the second parking assistance control. When the user wants to start the autonomous parking in the remote parking mode, the user performs a necessary operation by referring to a procedure for transitioning to the remote parking mode displayed on the autonomous parking-related screen. For example, the user shifts the vehicle 1 to parking, starts the application on the external device 2, gets out of the vehicle 1, locks doors, and then operates the application to input the start instruction for autonomous parking to the control device 30. The calculation unit 32 receives this start instruction and starts executing the first parking assistance control.

Note that the first parking assistance control includes control for turning off a power of the vehicle 1 after moving the vehicle 1 to the target position and stopping the vehicle 1. On the other hand, the second parking assistance control does not include the control for turning off the power of the vehicle 1 after moving the vehicle 1 to the target position and stopping the vehicle 1. That is, in the in-vehicle parking mode, after the autonomous parking is completed, the user turns off the power of the vehicle 1 at his or her own will. On the other hand, in the remote parking mode, after issuing the start instruction for autonomous parking, the power of the vehicle 1 is automatically turned off.

When the power of the vehicle 1 is in an off state, power supplied to devices other than specific devices such as devices necessary for detecting minimum necessary operations (for example, power-on operation), devices necessary for communication with the outside, devices necessary for updating programs described later, and devices included in a security system, is minimized, and the vehicle 1 enters a hibernation state.

The EPS system 40 includes a steering angle sensor 41, a torque sensor 42, an EPS motor 43, a resolver 44, and the EPS electronic control unit (EPS ECU) 45. The steering angle sensor 41 detects a steering angle θst of a steering 46. The torque sensor 42 detects a torque TQ applied to the steering 46.

The EPS motor 43 applies a driving force or a reaction force to a steering column 47 connected to the steering 46, thereby enabling assistance of an operation performed by the driver on the steering 46 and enabling automated steering in autonomous parking. The resolver 44 detects a rotation angle θm of the EPS motor 43. The EPS ECU 45 controls the entire EPS system 40. The EPS ECU 45 includes an input and output unit, a calculation unit, and a storage unit (all not shown).

The communication unit 50 is a communication interface that communicates with the external device 2 separate from the vehicle 1 under control of the control device 30. In the present embodiment, as an example, the external device 2 is a smartphone owned by the user. The control device 30 maycommunicate with the external device 2 via the communication unit 50. For example, a mobile communication network such as a cellular line, WI-FI (registered trademark), or Bluetooth (registered trademark) may be adopted for the communication between the vehicle 1 and the external device 2. The external device 2 may be managed by, for example, a manufacturer of the vehicle 1.

The driving force control system 60 includes a driving ECU 61. The driving force control system 60 executes driving force control of the vehicle 1. The driving ECU 61 controls a driving force of the vehicle 1 by controlling an engine, a motor, or the like (not shown) based on an operation performed on an accelerator pedal (not shown) by the user or an instruction from the control device 30. The driving ECU 61 includes an input and output unit, a calculation unit, and a storage unit (all not shown).

The braking force control system 70 includes a braking ECU 71. The braking force control system 70 executes braking force control of the vehicle 1. The braking ECU 71 controls a braking force of the vehicle 1 by controlling a brake mechanism or the like (not shown) based on an operation performed on a brake pedal (not shown) by the user. The braking ECU 71 includes an input and output unit, a calculation unit, and a storage unit (all not shown).

The storage unit 35 may store a program for travel control necessary for travel control of the vehicle 1. The programs including the program for travel control used to control the vehicle 1 are configured to be updated by downloading an updated version from an external server or the like connected via the communication unit 50. The vehicle 1 cannot be moved in updating the program for travel control. For this reason, it is preferable to update the programs including the program for travel control at a timing when the vehicle 1 is stopped for a long period of time. Programs to be updated in the vehicle 1 mayinclude programs stored not only in the storage unit 35 but also in any one of the storage unit of the EPS ECU 45, the storage unit of the driving ECU 61, and the storage unit of the braking ECU 71.

In the present embodiment, the calculation unit 32 updates the programs including the program for travel control after the first parking assistance control or the second parking assistance control is completed. For example, after the first parking assistance control is completed, the calculation unit 32 causes the display device of the external device 2 to display a screen for asking whether to update the programs. When an operation instructing to immediately start updating the programs is performed on this screen, the calculation unit 32 receives the instruction to start updating and starts updating the programs. Alternatively, after the first parking assistance control is completed, when an operation is performed on the above screen to instruct the programs to be updated after the next autonomous parking is completed, the calculation unit 32 starts updating the programs without asking the user for confirmation after the next autonomous parking is completed.

For example, after completing the second parking assistance control, the calculation unit 32 causes the touch panel 21 to display the above screen. When an operation instructing to immediately start updating the programs is performed on this screen, the calculation unit 32 receives the instruction to start updating and starts updating the programs after the power of the vehicle 1 is turned off. Alternatively, after the second parking assistance control is completed, when an operation is performed on the above screen to instruct the programs to be updated after the next autonomous parking is completed, the calculation unit 32 starts updating the programs without asking the user for confirmation after the next autonomous parking is completed and the power of the vehicle 1 is turned off.

If no user operation is detected for a predetermined period of time after displaying the above screen, the calculation unit 32 determines that the user intends to immediately start the update, and may receive a start instruction to update the programs.

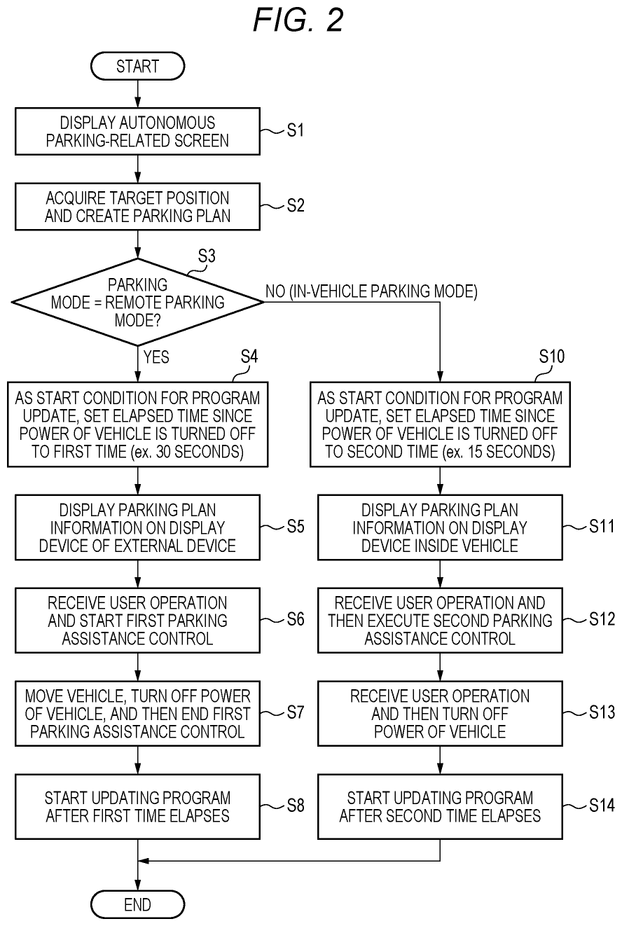

FIG. 2 is a flowchart for explaining processing of the control device 30 when performing the autonomous parking. When receiving an operation for executing the autonomous parking, the calculation unit 32 causes the touch panel 21 to display the autonomous parking-related screen (step S1). The user sets the parking position on this autonomous parking-related screen. The calculation unit 32 obtains the set parking position and then creates a parking plan (step S2). The parking plan defines following which path the vehicle 1 is moved to the set parking position.

Next, the calculation unit 32 determines whether the autonomous parking mode is the remote parking mode (step S3). If the autonomous parking mode is the remote parking mode (step S3: YES), the calculation unit 32 performs processing from step S4 to step S8, and if the autonomous parking mode is not the remote parking mode and is the in-vehicle parking mode (step S3: NO), the calculation unit 32 performs processing from step S10 to step S14.

In the case of the remote parking mode, the user starts the application on the external device 2, gets out of the vehicle 1, and locks the vehicle 1. In step S4, the calculation unit 32 sets a start condition for the updating of the programs to be performed after the remote parking mode ends (step S4). The start condition set here is a time-related condition that an elapsed time since the power of the vehicle 1 is turned off reaches a first time. The first time is not particularly limited, and is set to, for example, 30 seconds.

After step S4 or in parallel with step S4, the calculation unit 32 displays the parking plan information created in step S2 on an application screen of the external device 2 (step S5).

Next, the user operates the application screen of the external device 2 to instruct to start the autonomous parking. When receiving this instruction, the calculation unit 32 starts the first parking assistance control to start moving the vehicle 1 to the target position (step S6).

After step S6, the calculation unit 32 stops the vehicle 1 to end the autonomous parking, and then turns off the power of the vehicle 1 to complete the first parking assistance control (step S7). Note that after stopping the vehicle 1, the calculation unit 32 uses the application screen to ask the user whether to update the programs, and if the user gives a start instruction to update the programs, the calculation unit 32 may turn off the power of the vehicle 1.

After step S7, the calculation unit 32 counts the elapsed time since the power of the vehicle 1 is turned off, and if the elapsed time reaches the first time set in step S4, the calculation unit 32 starts updating the programs including the program for travel control (step S8).

In the case of the in-vehicle parking mode, the user operates the touch panel 21 and inputs a start instruction for autonomous parking to the control device 30. When receiving this start instruction, the calculation unit 32 sets a start condition for the updating of the programs to be performed after the in-vehicle parking mode ends (step S10). The start condition set here is also a time-related condition, similar to that set in step S4. In step S10, the calculation unit 32 sets a time-related condition that the elapsed time since the power of the vehicle 1 is turned off reaches a second time. The second time is a shorter value than the first time. The second time is not particularly limited, and is set to, for example, 15 seconds.

After step S10 or in parallel with step S10, the calculation unit 32 displays the parking plan information created in step S2 on the touch panel 21 (step S11).

Next, the user operates the touch panel 21 to instruct the start of the autonomous parking. When receiving this instruction, the calculation unit 32 starts the second parking assistance control to start moving the vehicle 1 to the target position (step S12).

After step S12, the calculation unit 32 stops the vehicle 1 to end the autonomous parking, and then completes the second parking assistance control without turning off the power of the vehicle 1.

Thereafter, if the user performs an operation to turn off the power of the vehicle 1, the calculation unit 32 turns off the power of the vehicle 1 (step S13). Then, the calculation unit 32 counts the elapsed time since the power of the vehicle 1 is turned off, and if the elapsed time reaches the second time set in step S10, the calculation unit 32 starts updating the programs including the program for travel control (step S14).

After the updating of the programs started in step S8 or step S14 is completed, the power of the vehicle 1 can be turned on and the vehicle 1 returns to a travelable state. Note that after the second parking assistance control is completed, the calculation unit 32 uses the touch panel 21 to ask the user whether to update the programs, and if the user gives a start instruction to update the programs, the calculation unit 32 may start updating the programs after the power of the vehicle 1 is turned off.

In the flowchart shown in FIG. 2, the processing of step S4 may be performed between step S5 and step S7. Similarly, the processing of step S10 may be performed between step S11 and step S13.

As described above, according to the vehicle 1, the time from when the power of the vehicle 1 is turned off until the updating of the programs is started when the first parking assistance control (remote parking mode) is executed is longer than that when the second parking assistance control (in-vehicle parking mode) is executed. In other words, when the first parking assistance control (remote parking mode) is executed, the start condition for updating the programs is set more strictly than when the second parking assistance control (in-vehicle parking mode) is executed. Therefore, after the first parking assistance control is completed and before the updating of the programs starts, it becomes possible to ensure enough time for the user who is outside the vehicle 1 to return to the inside of the vehicle and take measures such as moving the vehicle 1. As a result, for example, when it is desired to change the position where the vehicle 1 is stopped using the first parking assistance control, or to leave a parking lot immediately due to a change in plans, or the like, these changes can be implemented and convenience can be improved.

When the second parking assistance control that can be executed while the user is present in the vehicle 1 is executed, after stopping the vehicle 1, the user determines whether it is necessary to move the vehicle 1 thereafter, and then turns off the power of the vehicle 1, thereby starting the updating of the programs. In this way, when the power of the vehicle 1 is turned off at a will of the user, since the start condition is set so that the updating of the programs starts in a short time, a time required to complete the updating of the programs can be shortened.

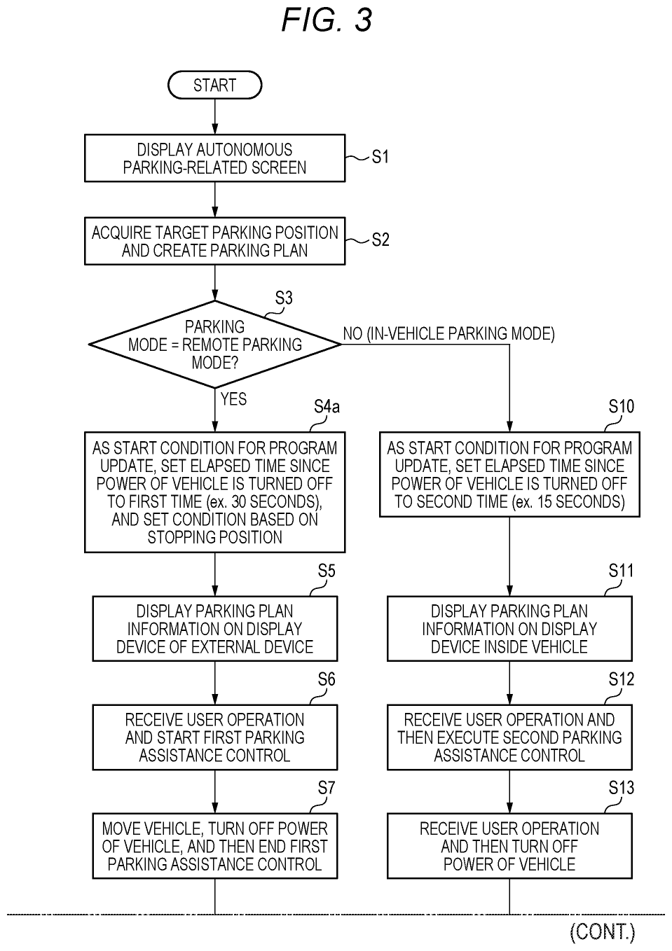

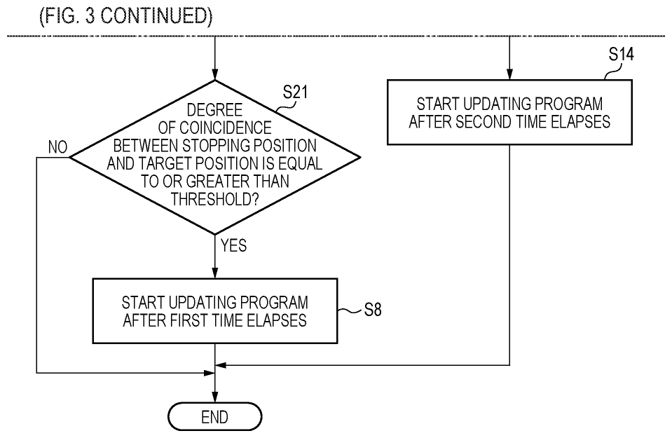

FIG. 3 is a flowchart for explaining a first modification of the processing of the control device 30 when performing the autonomous parking. The flowchart shown in FIG. 3 is the same as the flowchart shown in FIG. 2, except that step S4 is changed to step S4a and step S21 is added between step S7 and step S8.

In step S4a, the calculation unit 32 sets a start condition for the updating of the programs to be performed after the remote parking mode ends. In addition to the time-related condition described above, the start condition set here includes a condition based on the stopping position of the vehicle 1 after the remote parking mode ends. The condition based on the stopping position is a condition regarding a degree of match between the stopping position and the target position, and is that the degree of match is equal to or greater than a threshold. In the present modification, when the first parking assistance control (remote parking mode) is executed, by increasing the number of start conditions for updating the programs, the start conditions are set more strictly than when the second parking assistance control (in-vehicle parking mode) is executed.

After step S7, the calculation unit 32 determines the degree of match between the stopping position of the vehicle 1 moved by the first parking assistance control and the target position obtained in step S2 (step S21). If the degree of match is equal to or greater than the threshold (step S21: YES), when it is determined in step S8 that the elapsed time since the power of the vehicle 1 is turned off reaches the first time, the calculation unit 32 starts updating the programs. The calculation unit 32 does not update the programs if the degree of match is less than the threshold (step S21: NO). In this case, the calculation unit 32 may use the application screen to notify that the programs will not be updated this time.

As described above, according to the processing of the first modification, if the stopping position of the vehicle 1 deviates significantly from the target position, the updating of the programs is not started, and therefore, after the autonomous parking is completed, the user can turn on the power of the vehicle 1 and move the vehicle 1. Therefore, the user can modify the position of the vehicle 1, and the vehicle 1 can be stopped at an appropriate position.

Note that in the processing of the first modification, it is not essential that the first time set in step S4a be longer than the second time set in step S10, and the first time and the second time may have the same value. Even in this case, in the remote parking mode, by including a condition based on the stopping position as a start condition for updating the programs, the start condition is set more strictly than for the in-vehicle parking mode. That is, since in the remote parking mode, the updating of the programs is not started as easily as in the in-vehicle parking mode, various measures can be taken after the vehicle 1 is stopped, and convenience can be improved.

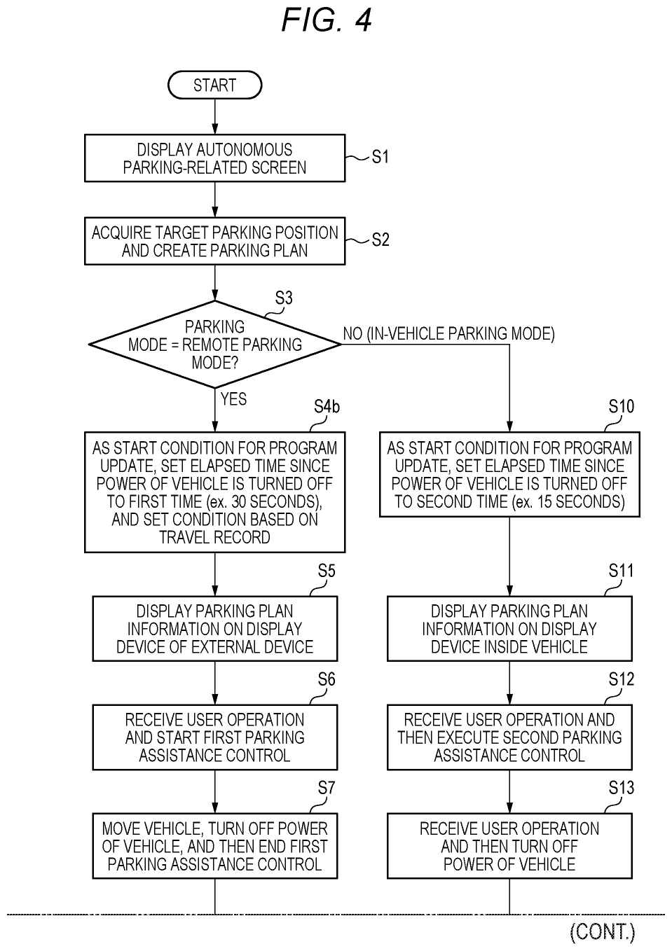

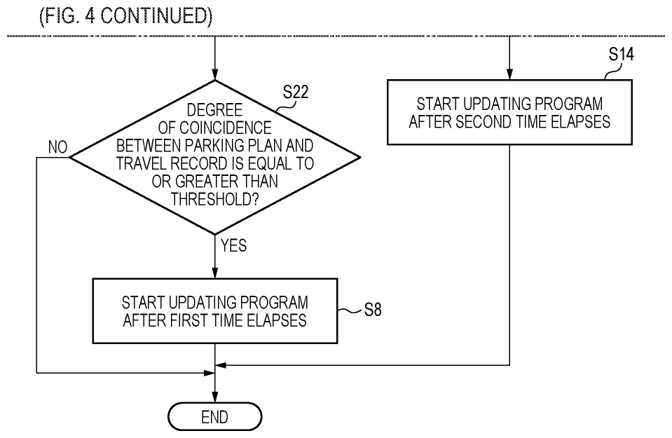

FIG. 4 is a flowchart for explaining a second modification of the processing of the control device 30 when performing autonomous parking. The flowchart shown in FIG. 4 is the same as the flowchart shown in FIG. 2, except that step S4 is changed to step S4b and step S22 is added between step S7 and step S8.

In step S4b, the calculation unit 32 sets a start condition for the updating of the programs to be performed after the remote parking mode ends. In addition to the time-related condition described above, the start condition set here includes a condition based on a travel record of the vehicle 1 in the remote parking mode. The condition based on the travel record is a condition regarding a degree of match between the travel record (travel details including a travel path) and the parking plan, and is that the degree of match is equal to or greater than a threshold. In the present modification, when the first parking assistance control (remote parking mode) is executed, by increasing the number of start conditions for updating the programs, the start conditions are set more strictly than when the second parking assistance control (in-vehicle parking mode) is executed.

After step S7, the calculation unit 32 determines the degree of match between the travel record of the vehicle 1 moved by the first parking assistance control and the parking plan created in step S2 (step S22). If the degree of match is equal to or greater than the threshold (step S22: YES), when it is determined in step S8 that the elapsed time since the power of the vehicle 1 is turned off reaches the first time, the calculation unit 32 starts updating the programs. The calculation unit 32 does not update the programs if the degree of match is less than the threshold (step S22: NO). In this case, the calculation unit 32 may use the application screen to notify that the programs will not be updated this time.

As described above, according to the processing of the second modification, if the travel record of the vehicle 1 deviates significantly from the parking plan, the updating of the programs is not started, and therefore, after the autonomous parking is completed, the user can turn on the power of the vehicle 1 and move the vehicle 1. For example, in a case where some abnormality occurs while the vehicle 1 is moved by the first parking assistance control and the vehicle 1 is not moved according to the parking plan, after the first parking assistance control is completed, it becomes possible for the user to restart the vehicle 1 and deal with the abnormality.

Note that in the processing of the second modification, it is not essential that the first time set in step S4b be longer than the second time set in step S10, and the first time and the second time may have the same value. Even in this case, in the remote parking mode, by including a condition based on the travel record as a start condition for updating the programs, the start condition is set more strictly than for the in-vehicle parking mode. That is, since in the remote parking mode, the updating of the programs is not started as easily as in the in-vehicle parking mode, various measures can be taken after the vehicle 1 is stopped, and convenience can be improved.

The first modification and the second modification can be combined. That is, in the remote parking mode, the calculation unit 32 may set a time-related condition, a condition based on the stopping position, and a condition based on the travel record as the start conditions for updating the programs, and in the in-vehicle parking mode, the calculation unit 32 may set only a time-related condition as the start condition for updating the programs. In this case, after the first parking assistance control is completed, if at least one of the degree of match between the parking plan and the travel record and the degree of match between the stopping position and the target position is less than the threshold, the calculation unit 32 may be configured not to update the programs.

When the programs are being updated, the calculation unit 32 preferably controls the display device of the external device 2 to display information regarding an update status. The information regarding the update status is, for example, information indicating progress of the update, information indicating the remaining time until the update is completed, and the like. After the updating of the programs is started, the user will be outside the vehicle 1, but information regarding the update status will be displayed on the display device of the external device 2 owned by the user, so that the user can easily know whether the update is completed and how long it will take to complete the update. In this way, it becomes possible to make a plan to return to the parking position of the vehicle 1 around the time the updating of the programs is completed, and convenience can be improved.

Note that when an update content for a programs is related to safety, such as a recall, it is preferable that the calculation unit 32 disables autonomous parking (both the first parking assistance control and the second parking assistance control). The calculation unit 32 confirms with the user whether it is necessary to update the programs, and as a result of the confirmation, if an instruction of not updating is given a predetermined number of times in succession, it is preferable that the calculation unit 32 disables the first parking assistance control between the first parking assistance control and the second parking assistance control.

Although an embodiment of the present disclosure has been described above with reference to the accompanying drawings, it is needless to say that the present disclosure is not limited to the embodiment. It is apparent that those skilled in the art can conceive of various modifications and changes within the scope described in the claims, and it is understood that such modifications and changes naturally fall within the technical scope of the present invention. In addition, the respective constituent elements in the above-described embodiment may be combined as desired without departing from the gist of the invention.

For example, in the above-described embodiment, a four-wheeled automobile was used as an example of the vehicle, but the present invention is not limited thereto. The vehicle to which the technique of the present disclosure is applicable may be a two-wheeled automobile (so-called motorcycle), a Segway (registered trademark), or the like.

In the present description, at least the following matters are described. Although corresponding constituent elements or the like in the above-described embodiment are shown in parentheses, the present invention is not limited thereto.
(1) A control device (control device 30) for a vehicle, the control device including:
   a processor (calculation unit 32) configured to perform parking assistance control for autonomously parking the vehicle to a target position; and
   a storage unit (storage unit 35) that stores a program (program for travel control) necessary for travel control of the vehicle, in which
   as the parking assistance control, the processor is configured to perform first parking assistance control for starting movement of the vehicle to the target position in a state where a user of the vehicle is not in the vehicle, and second parking assistance control for starting movement of the vehicle to the target position in a state where the user is in the vehicle,
   the processor is configured to update the program, after a power of the vehicle is turned off after the processor executes the first parking assistance control or the second parking assistance control, and
   a start condition for updating the program is set more strictly when the first parking assistance control is executed than when the second parking assistance control is executed.

According to (1), although it is not possible to move the vehicle while the program is being updated, by setting a strict start condition for updating the program when the first parking assistance control is executed while the user is outside the vehicle, the user who is outside the vehicle can take measures such as returning to the vehicle and moving the vehicle between the time when the power of the vehicle is turned off and the time when the updating of the program is started. As a result, for example, when it is desired to change the position where the vehicle is stopped using the first parking assistance control, or to leave a parking lot immediately due to a change in plans, or the like, these changes can be implemented and convenience can be improved.
(2) The control device for a vehicle according to (1), in which
   the first parking assistance control includes control for turning off the power of the vehicle after the vehicle is stopped, and
   the second parking assistance control does not include control for turning off the power of the vehicle.

According to (2), when the second parking assistance control that is executed while the user is present in the vehicle is executed, for example, after stopping the vehicle, the user determines whether it is necessary to move the vehicle thereafter, and then turns off the power of the vehicle, thereby starting the updating of the program. In this way, when the power of the vehicle is turned off at a will of the user, by setting the start condition so that the updating of the program starts in a short time, a time required to complete the updating of the program can be shortened. On the other hand, when the first parking assistance control is executed, the power of the vehicle is automatically turned off. For this reason, it is required to ensure a time after the end of the first parking assistance control until the user starts the vehicle and moves the vehicle. When executing the first parking assistance control, the start condition for updating the program become stricter, so that it is possible to ensure the above time, such as when it is desired to change the position of the vehicle, or to leave the parking lot immediately due to a change in plans, these changes can be implemented and convenience can be increased.
(3) The control device for a vehicle according to (1) or (2), in which
   when the processor executes the first parking assistance control, the start condition includes a degree of match between a stopping position, to which the vehicle is moved by the first parking assistance control, and the target position.

According to (3), when the stopping position of the vehicle deviates significantly from the target position, for example, by not starting updating of the program, it is possible to correct a position where the vehicle is stopped.
(4) The control device for a vehicle according to any one of (1) to (3), in which
   when the processor executes the first parking assistance control, the start condition includes a degree of match between a travel plan of the vehicle and a travel record of the vehicle by the first parking assistance control.

According to (4), when the travel record of the vehicle deviates significantly from the travel plan, for example, by not starting the updating of the program, it is possible to deal with troubles that occur during the first parking assistance control even after the vehicle is stopped.
(5) The control device for a vehicle according to any one of (1) to (4), in which
   the start condition includes a time from when the power of the vehicle is turned off to when the updating of the program is started, and
   the processor is configured to set the time longer when executing the first parking assistance control than when executing the second parking assistance control.

According to (5), when the first parking assistance control is executed, the time from when the power of the vehicle is turned off until the updating of the program is started becomes longer. Therefore, using this time, the user who is outside the vehicle can return to the inside of the vehicle and take measures such as moving the vehicle. As a result, for example, when it is desired to change the position where the vehicle is stopped using the first parking assistance control, or to leave a parking lot immediately due to a change in plans, or the like, these changes can be implemented and convenience can be improved.
(6) The control device for a vehicle according to any one of (1) to (5), in which
   after executing the first parking assistance control or the second parking assistance control, the processor is configured to update the program after the power of the vehicle is turned off and a start instruction for updating the program is received, and
   the processor is configured to cause a second display device (display device of external device 2) different from a first display device (touch panel 21) mounted on the vehicle to display a screen for confirming the start instruction when the first parking assistance control is executed, and cause the first display device to display the screen when the second parking assistance control is executed.

According to (6), the screen can be displayed at appropriate positions when performing the first parking assistance control and when performing the second parking assistance control, and the user can reliably execute the start instruction to start updating the program.
(7) The control device for a vehicle according to (6), in which
   the processor causes the second display device to display information regarding an update status of the program after receiving the start instruction.

According to (7), since the update status is displayed on the second display device (for example, a display device such as a smartphone owned by the user) instead of the first display device mounted on the vehicle, even when the user is outside the vehicle, the user can easily know the update status of the program. In this way, it becomes possible to make a plan to return to the position of the vehicle around the time the updating of the program is completed, and convenience can be improved.
(8) The control device for a vehicle according to any one of (1) to (4), in which the user is a driver of the vehicle.
(9) A control device (control device 30) for a vehicle, the control device including:
   a processor (calculation unit 32) configured to perform parking assistance control for autonomously parking the vehicle to a target position; and
   a storage unit (storage unit 35) that stores a program (program for travel control) necessary for travel control of the vehicle, in which
   the processor is configured to perform first parking assistance control for starting movement of the vehicle to the target position in a state where a user of the vehicle is not in the vehicle as the parking assistance control,
   the processor is configured to update the program, after a power of the vehicle is turned off and the processor executes the first parking assistance control, and
   the processor is configured to determine whether to update the program based on a stopping position to which the vehicle is moved by the first parking assistance control and the target position.

According to (9), although it is not possible to move the vehicle while the program is being updated, when the first parking assistance control is executed and the stopping position of the vehicle deviates significantly from the target position, for example, by not starting updating of the program, the user can correct a position where the vehicle is stopped. On the other hand, when the stopping position of the vehicle substantially matches the target position, for example, by starting the updating of the program, the program can be kept up to date and optimal travel control can be achieved.
(10) A control device (control device 30) for a vehicle, the control device including:
a processor (calculation unit 32) configured to perform parking assistance control for autonomously parking the vehicle to a target position according to a travel plan; and
a storage unit (storage unit 35) that stores a program (program for travel control) necessary for travel control of the vehicle, in which
the processor is configured to perform first parking assistance control for starting movement of the vehicle to the target position in a state where a user of the vehicle is not in the vehicle as the parking assistance control,
the processor is configured to update the program, after a power of the vehicle is turned off and the processor executes the first parking assistance control, and
the processor is configured to determine whether to update the program based on a travel record of the vehicle moved by the first parking assistance control and the travel plan.

According to (10), although it is not possible to move the vehicle while the program is being updated, when the first parking assistance control is executed and the travel record of the vehicle deviates significantly from the travel plan, for example, by not starting updating of the program, it is possible to deal with troubles that occur during the first parking assistance control. On the other hand, when the travel record of the vehicle substantially matches the travel plan, for example, by starting the updating of the program, the program can be kept up to date and optimal travel control can be achieved.

1. A control device for a vehicle, the control device comprising:
a processor configured to perform parking assistance control for autonomously parking the vehicle to a target position; and
a storage unit that stores a program necessary for travel control of the vehicle, wherein
as the parking assistance control, the processor is configured to perform first parking assistance control for starting movement of the vehicle to the target position in a state where a user of the vehicle is not in the vehicle, and second parking assistance control for starting movement of the vehicle to the target position in a state where the user is in the vehicle,
the processor is configured to update the program, after a power of the vehicle is turned off and the processor executes the first parking assistance control or the second parking assistance control, and
a start condition for updating the program is set more strictly when the first parking assistance control is executed than when the second parking assistance control is executed.

2. The control device for a vehicle according to claim 1, wherein
the first parking assistance control includes control for turning off the power of the vehicle after the vehicle is stopped, and
the second parking assistance control does not include control for turning off the power of the vehicle.

3. The control device for a vehicle according to claim 1, wherein
when the processor executes the first parking assistance control, the start condition includes a degree of match between a stopping position, to which the vehicle is moved by the first parking assistance control, and the target position.

4. The control device for a vehicle according to claim 1, wherein
when the processor executes the first parking assistance control, the start condition includes a degree of match between a travel plan of the vehicle and a travel record of the vehicle by the first parking assistance control.

5. The control device for a vehicle according to claim 1, wherein
the start condition includes a time from when the power of the vehicle is turned off to when the updating of the program is started, and
the processor is configured to set the time longer when executing the first parking assistance control than when executing the second parking assistance control.

6. The control device for a vehicle according to claim 1, wherein
after executing the first parking assistance control or the second parking assistance control, the processor is configured to update the program after the power of the vehicle is turned off and a start instruction for updating the program is received, and
the processor is configured to cause a second display device different from a first display device mounted on the vehicle to display a screen for confirming the start instruction when the first parking assistance control is executed, and cause the first display device to display the screen when the second parking assistance control is executed.

7. The control device for a vehicle according to claim 6, wherein
the processor is configured to cause the second display device to display information regarding an update status of the program after receiving the start instruction.

8. The control device for a vehicle according to claim 1, wherein
the user is a driver of the vehicle.

9. A control device for a vehicle, the control device comprising:
a processor is configured to perform parking assistance control for autonomously parking the vehicle to a target position; and
a storage unit that stores a program necessary for travel control of the vehicle, wherein
the processor is configured to perform first parking assistance control for starting movement of the vehicle to the target position in a state where a user of the vehicle is not in the vehicle as the parking assistance control,
the processor is configured to update the program, after a power of the vehicle is turned off and the processor executes the first parking assistance control, and
the processor is configured to determine whether to update the program based on a stopping position to which the vehicle is moved by the first parking assistance control and the target position.

10. A control device for a vehicle, the control device comprising:
a processor configured to perform parking assistance control for autonomously parking the vehicle to a target position according to a travel plan; and
a storage unit that stores a program necessary for travel control of the vehicle, wherein
the processor is configured to perform first parking assistance control for starting movement of the vehicle to the target position in a state where a user of the vehicle is not in the vehicle as the parking assistance control,
the processor is configured to update the program, after a power of the vehicle is turned off and the processor executes the first parking assistance control, and
the processor is configured to determine whether to update the program based on a travel record of the vehicle moved by the first parking assistance control and the travel plan.
